(19) United States
(12) Patent Application Publication
(10) Pub. No.: US 2015/0379573 A1
(43) Pub. Date: Dec. 31, 2015

(54) ELECTRONIC CONTENT FILTERING SERVER BETWEEN A MOBILE COMPUTING DEVICE AND AN ELECTRONIC RECEIPT SERVER

(71) Applicant: TOSHIBA TEC KABUSHIKI KAISHA, Tokyo (JP)

(72) Inventor: Kenya HIRAMATSU, Kita Tokyo (JP)

(21) Appl. No.: 14/753,763

(22) Filed: Jun. 29, 2015

(30) Foreign Application Priority Data
Jun. 30, 2014 (JP) 2014-135276

(51) Int. Cl. G06Q 30/02; H04L 29/08

(52) U.S. Cl. CPC G06Q 30/0259; H04L 67/10; H04L 67/18; G06Q 30/0261; G06Q 30/0267

(57) ABSTRACT

An electronic content filtering server includes a communication unit and a processing unit. The communication unit is configured to receive from a mobile computing device a request for promotion information and a location of the mobile computing device, and from an electronic receipt server, store information of stores where a product being promoted has been sold. The processing unit is programmed to perform a filtering function on the store information and supply a filtered result to the mobile computing device through the communication unit. The processing unit, when performing the filtering function, determines a distance between the mobile computing device and each of the stores where the product has been sold, selects one or more stores based on the distance, and generates the filtered result including a product name of the product being promoted, and a store name of and a distance to each of the selected stores.

### CROSS-REFERENCE TO RELATED APPLICATION

This application is based upon and claims the benefit of priority from Japanese Patent Application No. 2014-135276, filed Jun. 30, 2014, the entire contents of which are incorporated herein by reference.

### FIELD

Embodiments described herein relate generally to an electronic content filtering sever between a mobile computing device and an electronic receipt server.

### BACKGROUND

In the related art, promotional information of a product, such as advertisement and sales promotion, are contained in various websites and uploaded to the Internet. By selecting the promotional information on a computing device, a user can access detailed information of the product being promoted.

Some products may be exclusively or typically sold at a store, and consumers may need to visit the store to purchase these products. In addition, some consumers may prefer to visit a store to purchase a product being promoted on the Internet, even though the product can be purchased through the Internet (i.e., through online shopping). When consumers view the promotional information of a product on the Internet and visit a store to purchase the product, the consumers may want to know which stores currently sell the product. When there are a lot of stores that sells the product being promoted, the consumers may want to know further which of the stores may be convenient to the consumers.

### DESCRIPTION OF THE DRAWINGS

FIG. 1 illustrates a configuration of an electronic receipt system according to an embodiment.

FIG. 2 is a block diagram of a POS terminal in the electronic receipt system.

FIG. 3 is a block diagram of an electronic receipt server in the electronic receipt system.

FIG. 4 is a block diagram of an electronic receipt management server in the electronic receipt system.

FIG. 5 illustrates a data configuration of a membership table stored in the electronic receipt management server.

FIG. 6 illustrates a data configuration of a purchase history table stored in the electronic receipt management server.

FIG. 7 is a block diagram of an information distribution server in the electronic receipt system.

FIG. 8 illustrates a data configuration of a store setting table stored in the information distribution server.

FIG. 9 is a block diagram of a user terminal in the electronic receipt system.

FIG. 10 illustrates a functional configuration relating to provision of electronic receipts in the electronic receipt system.

FIG. 11 is a flowchart of a process relating to provision of electronic receipts carried out in the electronic receipt system.

FIG. 12 illustrates a functional configuration relating to a sales promotion in the electronic receipt system.

FIG. 13 illustrates an example of a sales promotion screen.

FIG. 14 is a flowchart of a process relating to the sales promotion carried out in the electronic receipt system.

FIG. 15 is a flowchart of a process relating to a process to generate sales promotion screen information carried out in the electronic receipt system.

### DETAILED DESCRIPTION

In general, according to one embodiment, an electronic content filtering server between a mobile computing device and an electronic receipt server includes a communication unit and a processing unit. The communication unit is configured to communicate with the mobile computing device and the electronic receipt server, and to receive from the mobile computing device a request for promotion information and a location of the mobile computing device, and from the electronic receipt server, store information of stores where a product being promoted has been sold. The processing unit is programmed to perform a filtering function on the store information received from the electronic receipt server and supply a filtered result to the mobile computing device through the communication unit. The processing unit, when performing the filtering function, carries out the steps of: determining a distance between the location of the mobile computing device and each of the stores where the product being promoted has been sold; selecting one or more stores based on a distance from the mobile computing device; and generating the filtered result to be supplied to the mobile computing device, the filtered result including a product name of the product being promoted, and a store name of and a distance to each of the selected stores.

An embodiment will be described with reference to the drawings.

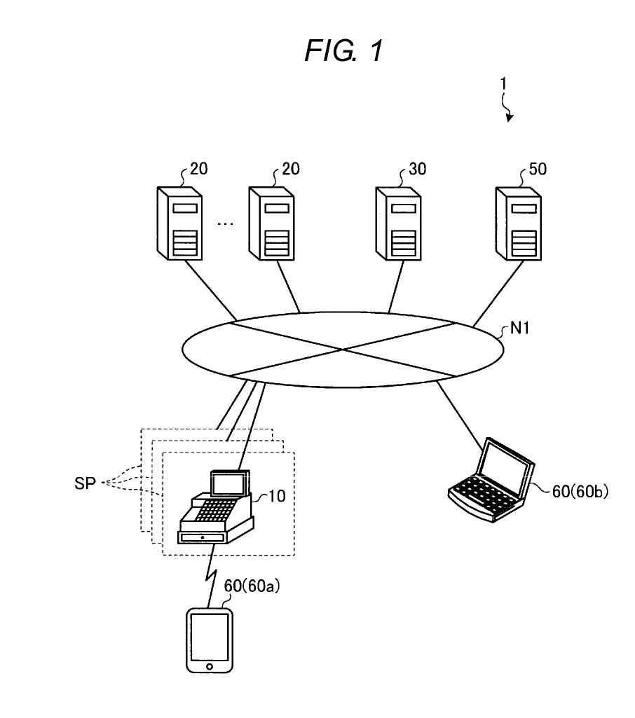

FIG. 1 illustrates an entire configuration of an electronic receipt system 1 according to an exemplary embodiment. As shown in FIG. 1, the electronic receipt system 1 includes a POS terminal 10, an electronic receipt server 20, an electronic receipt management server 30, an information distribution server 50, and a user terminal 60. Here, each device of the electronic receipt system 1 is connected to a network N1 such as the Internet.

Hereinafter, each device configuring the electronic receipt system 1 will be described.

POS Terminal

First, the POS terminal 10 will be described. The POS terminal 10 is a merchandise sales data processing device and executes merchandise sales data processing. The POS terminal 10 is, for example, located in a store SP such as a supermarket or a convenience store.

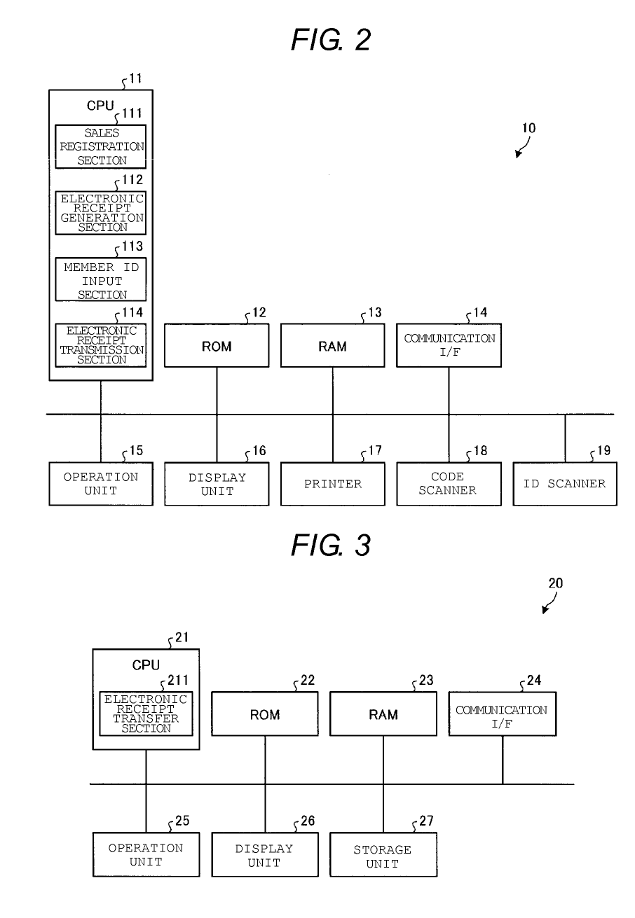

FIG. 2 is a block diagram of the POS terminal 10. As shown in FIG. 2, the POS terminal 10 includes a central processing unit (CPU) 11, a read only memory (ROM) 12, a random access memory (RAM) 13, a communication I/F 14, an operation unit 15, a display unit 16, a printer 17, a code scanner 18, and an ID scanner 19. The POS terminal 10 includes a clock device such as a real time clock (RTC) (not shown).

The ROM 12 stores various programs executed by the CPU 11 and various data. The RAM 13 temporarily stores data or programs when the CPU 11 executes various programs. The CPU 11 generates functional sections such as a sales registration section 111, an electronic receipt generation section 112, a member ID input section 113, and an electronic receipt transmission section 114 by expanding the various programs stored in the ROM 12 to the RAM 13 and executing the programs. The functional sections will be described in detail.

The communication I/F 14 is a communication interface that is configured to be connected to the network N1. The POS terminal 10 may communicate with a device connected to the network N1 through the communication I/F 14.

The operation unit 15 is an input device such as a keyboard or a pointing device. Such a keyboard includes a numeric keypad with numbers, arithmetic operators, and a closing key for completing one transaction. The operation unit 15 receives an operation of an operator and outputs the operation content to the CPU 11.

The display unit 16 is a display device such as liquid crystal display (LCD). The display unit 16 displays various kinds of information including transaction content, under the control of the CPU 11. The display unit 16 may include a display device for a customer and a display device for an operator. The display unit 16 may have a touch panel. In this case, the touch panel functions as the operation unit 15.

The printer 17 is a printing device which performs printing on a sheet such as receipt paper. The printer 17 prints content of a transaction on the sheet, under control of the CPU 11.

The code scanner 18 is a reading device which reads a code symbol such as a barcode. The code scanner 18 reads a code symbol printed on merchandise and outputs a merchandise ID included in the code symbol to the CPU 11. Here, the merchandise ID is a merchandise identifier for identifying each merchandise item such as a JAN code.

The ID scanner 19 is a reading device which reads member IDs assigned to customers. Here, the customer using the electronic receipt system 1 performs member registration in advance and acquires a unique member ID. The member ID is contained in a storage medium such as a magnetic card, IC card, or the user terminal 60 (portable terminal 60a).

The ID scanner 19 reads the member ID from the storage medium presented by the customer and outputs the member ID to the CPU 11. A method of reading the member ID is not particularly limited. For example, when the member ID is contained in a magnetic card, a magnetic card reader is used as the ID scanner 19. When the member ID is contained in an IC card, an IC card reader is used as the ID scanner 19. When the member ID is contained in the portable terminal 60a, a communication device which may communicate with the portable terminal 60a by a communication method such as near field communication (NFC) is used as the ID scanner 19. When the member ID is presented as a code symbol on a paper medium or display screen of the portable terminal 60a, the code scanner 18 may be used as the ID scanner 19.

The POS terminal 10 performs sales registration of merchandise purchased by a customer. The POS terminal 10 transmits details of merchandise (merchandise ID) purchased by a customer, purchase date and time, a purchase place (store), and the like to the electronic receipt server 20 as electronic receipt information, together with the member ID read by the ID scanner 19. The POS terminal 10 outputs the details of the purchased merchandise purchased to the printer 17, according to a request from the customer.

Electronic Receipt Server

Next, the electronic receipt server 20 will be described. The electronic receipt server 20 is provided for a company that operates one or more stores SP. The electronic receipt server 20 functions as a receipt management server for a company and manages electronic receipt information of the company. Ahead office server of a POS system having functions such as sales management, sales analysis, or inventory management of the company may be used as the electronic receipt server 20.

FIG. 3 is a block diagram of the electronic receipt server 20. As shown in FIG. 3, the electronic receipt server 20 includes a CPU 21, a ROM 22, a RAM 23, a communication I/F 24, an operation unit 25, a display unit 26, and a storage unit 27. The electronic receipt server 20 includes a clock device such as an RTC (not shown).

The ROM 22 stores various programs executed by the CPU 21 and various data. The RAM 23 temporarily stores data or a program, when the CPU 21 executes various programs. The CPU 21 generates functional sections such as an electronic receipt transfer section 211 by expanding the various programs stored in the ROM 22 or the storage unit 27 into the RAM 23 and executing the programs. The functional sections will be described in detail.

The communication I/F 24 is a communication interface that is configured to be connected to the network N1. The electronic receipt server 20 may communicate with a device connected to the network N1 through the communication I/F 24. The operation unit 25 is an input device such as a keyboard or a pointing device. The operation unit 25 receives an operation of an operator and outputs the operation content to the CPU 21. The display unit 26 is a display device such as an LCD. The display unit 26 displays various kinds of information under the control of the CPU 21.

The storage unit 27 is a storage device such as a hard disk drive (HDD) or a solid state drive (SSD). The storage unit 27 stores various programs executed by the CPU 21 and various data.

The electronic receipt server 20 transfers the electronic receipt information transmitted from the store SP (POS terminal 10), which is controlled by the electronic receipt server 20, to an electronic receipt management server 30.

Electronic Receipt Management Server

Next, the electronic receipt management server 30 will be described. The electronic receipt management server 30 is a server device which collectively manages the electronic receipt information of multiple companies operating the stores. The electronic receipt management server 30 is, for example, managed by a third party organization other than the company which manages the electronic receipt information using the electronic receipt server 20. Alternatively, the electronic receipt server 20, as well as the electronic receipt management server 30, may be managed by a third party organization.

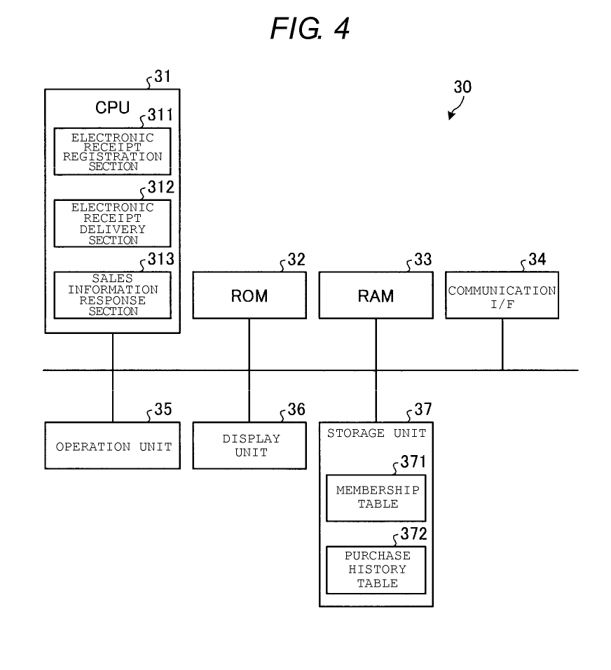

FIG. 4 is a block diagram of the electronic receipt management server 30. As shown in FIG. 4, the electronic receipt management server 30 includes a CPU 31, a ROM 32, a RAM 33, a communication I/F 34, an operation unit 35, a display unit 36, and a storage unit 37. The electronic receipt management server 30 includes a clock device such as an RTC (not shown).

The ROM 32 stores various programs executed by the CPU 31 and various data. The RAM 33 temporarily stores data or a program, when the CPU 31 executes various programs. The CPU 31 generates functional sections such as an electronic receipt registration section 311, an electronic receipt delivery section 312, and a sales information response section 313 by expanding the various programs stored in the ROM 32 or the storage unit 37 into the RAM 33 and executing the programs. The functional sections will be described in detail.

The communication I/F 34 is a communication interface that is configured to be connected to the network N1. The electronic receipt management server 30 may communicate with a device connected to the network N1 through the communication I/F 34. The operation unit 35 is an input device such as a keyboard or a pointing device. The operation unit 35 receives an operation of an operator and outputs the operation content to the CPU 31. The display unit 36 is a display device such as an LCD. The display unit 36 displays various kinds of information, under the control of the CPU 31.

The storage unit 37 is an HDD or an SSD. The storage unit 37 stores various programs executed by the CPU 31 and various data. The storage unit 37 stores tables (database) for storing various data relating to the electronic receipt system. Examples of such tables include a membership table 371 and a purchase history table 372.

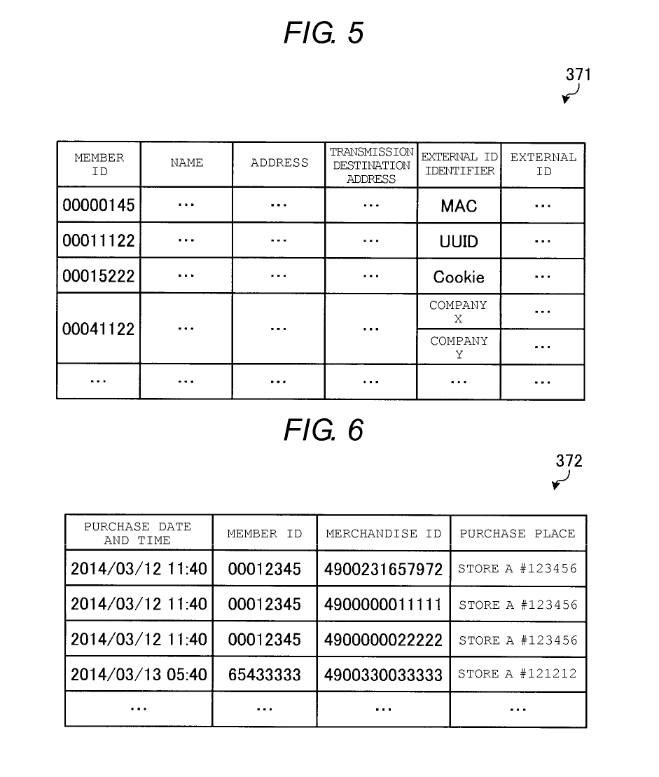

The membership table 371 is a data table for managing information (membership information) relating to a customer (member) who has completed the membership registration. FIG. 5 illustrates a data configuration of the membership table 371. As shown in FIG. 5, the membership table 371 includes sections for storing a member ID, a name, an address, a transmission destination address, an external ID identifier, and an external ID, respectively.

Here, symbols for identifying a member such as unique character string or numbers assigned to each member through the membership registration are stored in the column of the member ID. A name and an address input by the member through the membership registration are stored in the column of name and the column of address, respectively. Address information such as an email address, which is set as a transmission destination of the electronic receipt, is stored in the column of the transmission destination address.

In the column of external ID classification, classification of an identifier assigned to the member other than the member ID (hereinafter, referred to as external ID) is stored. For example, a MAC address (MAC), a universally unique identifier (UUID), or session ID (cookie) of the user terminal 60 assigned to the member, is included in the external ID classification. When the customer is a member of a system (service) other than the electronic receipt system, a service name (for example, company name) of the other service or the like is stored. An external ID that is an identifier in the external ID classification is stored in the column of external ID.

Among the member information described above, at least the member ID is registered at the time of the membership registration. The name, the address, the transmission destination address, the external ID identifier, and the external ID may be registered during or after the member registration. As a method of registering the external ID identifier and external ID, various registration methods may be used. For example, both of the member ID and the external ID (external ID identifier) may be included in sales promotion history information transmitted from the information distribution server 50. In this case, the electronic receipt management server 30 registers the external ID (external ID identifier) received together with the member ID, in correlation with the corresponding member ID in the membership table 371.

The data configuration of the membership table 371 is not limited to the example of FIG. 5. There may be a member who does not fill some or all columns for name, address, transmission destination address, external ID identifier, and external ID.

The purchase history table 372 is a data table for managing the electronic receipt information. FIG. 6 illustrates a data configuration of the purchase history table 372. As shown in FIG. 6, the purchase history table 372 includes sections for storing purchase date and time, a member ID, a merchandise ID, and a purchase place, which are included in the electronic receipt information. Here, a store ID of the store SP at which the purchase transaction has been performed, is stored in the column of the purchase place.

When the electronic receipt information is received from the electronic receipt server 20, the electronic receipt management server 30 registers various kinds of information included in the electronic receipt information in the purchase history table 372. In the present embodiment, the electronic receipt information is received through the electronic receipt server 20, but the electronic receipt information may be directly received from POS terminal 10.

The electronic receipt management server 30 supplies the electronic receipt information correlated to the member ID of the customer to the transmission destination address associated with the member ID, according to the request from the customer.

Information Distribution Server

Next, the information distribution server 50 will be described. The information distribution server 50 is a server device which supplies sales promotion information to a customer using the electronic receipt system.

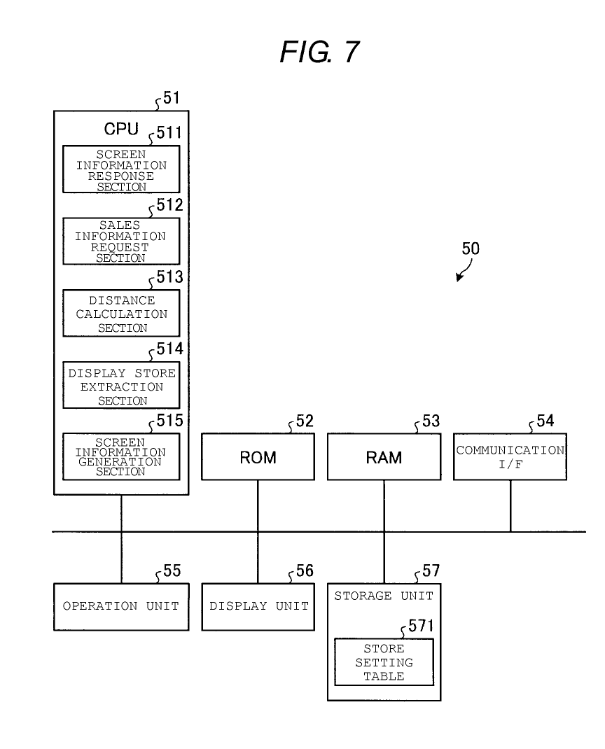

FIG. 7 is a block diagram of the information distribution server 50. As shown in FIG. 7, the information distribution server 50 includes a CPU 51, a ROM 52, a RAM 53, a communication I/F 54, an operation unit 55, a display unit 56, and a storage unit 57. The information distribution server 50 includes a clock device such as an RTC (not shown).

The ROM 52 stores various programs executed by the CPU 51 and various data. The RAM 53 temporarily stores data or a program, when the CPU 51 executes various programs. The CPU 51 generates functional sections such as a screen information response section 511, a sales information request section 512, a distance calculation section 513, a display store extraction section 514, and a screen information generation section 515 by expanding the various programs stored in the ROM 52 or the storage unit 57 into RAM 53 and executing the programs. The functional sections will be described in detail.

The communication I/F 54 is a communication interface that is configured to be connected to the network N1 and a network N2. The information distribution server 50 is configured to communicate with a device connected to the network N1 and the network N2, through the communication I/F 54. The operation unit 55 is an input device such as a keyboard or a pointing device. The operation unit 55 receives an operation of an operator and outputs the operation content to the CPU 51. The display unit 56 is a display device such as an LCD. The display unit 56 displays various kinds of information, under the control of the CPU 51.

The storage unit 57 is an HDD or an SSD. The storage unit 57 stores various programs executed by the CPU 51 and various data. The storage unit 57 stores content or sales promotion setting information. The storage unit 57 stores a store setting table 571 as a table (database) for storing various data items relating to the electronic receipt system.

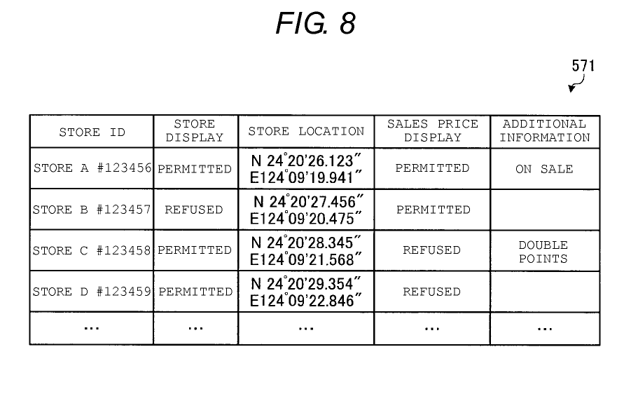

The store setting table 571 is a database for managing setting information relating to display of a sales promotion screen. FIG. 8 illustrates a data configuration of the store setting table 571. As shown in FIG. 8, the store setting table 571 includes columns for storing store ID, store display availability, store location, sales price display availability, and additional information. Data for identifying a store, such as unique character string and numbers, are stored in the column of the store ID. Availability of displaying a store on the sales promotion screen is stored in the column of the store display availability. Location of a store is stored in the column of the store location. For the store location shown in FIG. 8, longitude and latitude are used. The store location is not limited to longitude and latitude. The store location may be, for example, an address (physical address). Setting whether or not to display the sales price included in the sales information on the sales promotion screen is stored in the column of the sales price display availability. Additional information displayed on the screen relating to the sales promotion is stored in the column of the additional information. For the additional information shown in FIG. 8, character string is set. The additional information is not limited to the character string. For example, the additional information may be an image, a moving image, or a voice.

The information supply distribution 50 provides the sales promotion information to the user terminal 60 according to the setting in the store setting table 571.

Here, a method of providing the sales promotion information is not particularly limited. The sales promotion information may be provided through a web page by setting the information supply distribution 50 as a web server, for example. In addition, the sales promotion information may be provided through an email by setting the information supply distribution as an email server. Further, the sales promotion information may be provided as a video image by setting the information supply distribution 50 as a video image delivery server.

User Terminal

The user terminal 60 will be described. The user terminal 60 is a terminal device used by a customer who uses the electronic receipt system 1. As the user terminal 60, a portable user terminal 60a such as a smart phone or a stationary user terminal 60b such as a personal computer (PC) are used, for example.

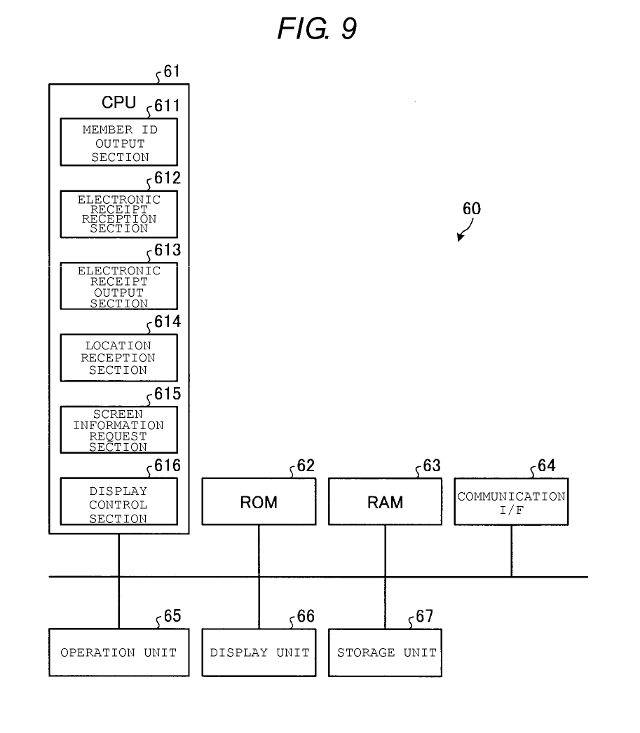

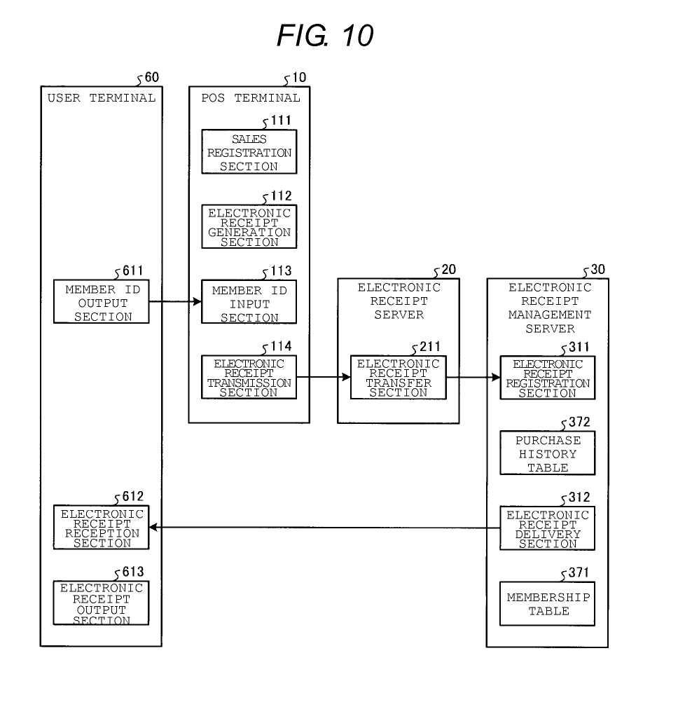

FIG. 9 is a block diagram of the user terminal 60. As shown in FIG. 9, the user terminal 60 includes a CPU 61, a ROM 62, a RAM 63, a communication I/F 64, an operation unit 65, a display unit 66, and a storage unit 67. The user terminal 60 includes a clock device such as an RTC (not shown).

The ROM 62 stores various programs executed by the CPU 61 and various data. The RAM 63 temporarily stores data or a program, when the CPU 61 executes various programs. The CPU 61 generates functional sections such as a member ID output section 611, an electronic receipt reception section 612, an electronic receipt output section 613, a location reception section 614, a screen information request section 615, and a display control section 616 by expanding the various programs stored in the ROM 62 or the storage unit 67 into the RAM 63 and executing the programs. The functional components will be described in detail.

The communication I/F 64 is a communication interface that is configured to be connected to the network N1 or the network N2. The user terminal 60 may communicate with a device connected to the network N2 through the communication I/F 64. A communication interface which may perform short-range communication such as NFC may be included as the communication I/F 64.

The operation unit 65 is an input device such as a keyboard, a pointing device, or a touch panel. The operation unit 65 receives an operation of an operator and outputs the operation content to the CPU 61. The display unit 66 is a display device such as an LCD. The display unit 66 displays various kinds of information, under the control of the CPU 61.

The storage unit 67 is an HDD or an SSD. The storage unit 67 stores various programs executed by the CPU 61 and various data. The storage unit 67, for example, stores programs such as a web browser or an email client. The storage unit 67 also stores the member ID or the external ID.

When the sales promotion information is acquired from the information distribution server 50, the user terminal 60 transmits sales promotion history information indicating the acquisition thereof to the electronic receipt management server 30. The date and time when the sales promotion information is acquired (sales promotion date and time), the sales promotion ID included in the sales promotion information, the member ID, the external ID (external ID identifier), and the like are included in the sales promotion history information. Here, the member ID and the external ID are acquired by a mechanism included in the sales promotion information as described above. The sales promotion history information may be transmitted to the electronic receipt management server 30 through the information distribution server 50.

The user terminal 60 (60b) performs proximity communication with the ID scanner 19 of the POS terminal 10, and transmits the information such as the member ID to the POS terminal 10. When the user terminal 60b stores electronic payment information that enables electronic payment, the user terminal 60b may transmit the electronic payment information to the POS terminal 10.

The user terminal 60 acquires the electronic receipt information from the electronic receipt management server 30, and outputs the electronic receipt information to the display unit 66. Here, a method of acquiring the electronic receipt information is not particularly limited. For example, a pull-type acquisition method of acquiring the electronic receipt information by transmitting an acquisition request with the indicated member ID to the electronic receipt management server 30 from the user terminal 60, may be used. A push-type acquisition method of acquiring the electronic receipt information automatically supplied (delivered) from the electronic receipt management server 30 may be used. In any cases, an email address or the like of the user terminal 60 is registered in the delivery destination information of the membership table 371.

Next, the functional components of each device described above will be described.

Provision of Electronic Receipts

First, a functional configuration of the electronic receipt system relating to provision of the electronic receipt information will be described. FIG. 10 illustrates the functional configuration relating to provision of electronic receipts carried out in the electronic receipt system 1.

As shown in FIG. 10, the POS terminal 10 includes the sales registration section 111, the electronic receipt generation section 112, the member ID input section 113, and the electronic receipt transmission section 114 as functional components of the electronic receipt system 1. The electronic receipt server 20 includes the electronic receipt transfer section 211 as a functional component of the electronic receipt system 1. The electronic receipt management server 30 includes the electronic receipt registration section 311 and the electronic receipt delivery section 312 as functional components of the electronic receipt system 1. The user terminal 60 includes the member ID output section 611, the electronic receipt reception section 612, and the electronic receipt output section 613 as functional components of the electronic receipt system 1.

The sales registration section 111 of the POS terminal 10 reads merchandise information, such as a merchandise name or a sales price of merchandise associated with the merchandise ID, which is read from the merchandise by the code scanner 18, from a merchandise master (not shown) and performs the sales registration of the merchandise using the merchandise information. The merchandise sales data process relating to the sales registration of the merchandise is the same as a process in the well-known technology, and therefore the description thereof will be omitted.

When an issue instruction of the electronic receipt is input, the electronic receipt generation section 112 of the POS terminal 10 generates electronic receipt information using the merchandise ID of merchandise subjected to the sales registration by the sales registration section 111.

The member ID input section 113 of the POS terminal 10 receives the input of the member ID from a storing medium such as the user terminal 60b carried by the customer through the ID scanner 19. Here, the member ID output section 611 of the user terminal 60b communicates with the member ID input section 113 through the communication I/F 64 and outputs the member ID stored in the own apparatus to the POS terminal 10. The acquisition target of the member ID is not limited to the user terminal 60b and a magnet card or an IC card may be used.

The electronic receipt transmission section 114 of the POS terminal 10 transmits the electronic receipt information including the merchandise purchased through the purchase transaction and registered by the sales registration section 111, to the electronic receipt server 20. More specifically, the electronic receipt transmission section 114 transmits the electronic receipt information generated by the electronic receipt generation section 112, the date and time when the sales registration is completed (purchase date and time), the member ID acquired by the member ID input section 113, and the store ID previously set in the own apparatus to the electronic receipt management server 30 as the electronic receipt information. When the member ID is not acquired, the electronic receipt transmission section 114 transmits the electronic receipt information by leaving the column of the member ID blank.

The electronic receipt transfer section 211 of the electronic receipt server 20 receives the electronic receipt information transmitted from the POS terminal 10. The electronic receipt transfer section 211 transmits (transfers) the received electronic receipt information to the electronic receipt management server 30. The timing of transferring the electronic receipt information to the electronic receipt management server 30 is not particularly limited. For example, the electronic receipt information may be transferred each time the electronic receipt information is received. Alternatively, the electronic receipt information for a predetermined period (for example, for one day) may be stored in the storage unit 27 or database and the stored electronic receipt information may be collectively transferred at a predetermined timing.

The electronic receipt registration section 311 of the electronic receipt management server 30 receives the electronic receipt information transmitted from each of the electronic receipt servers 20. The electronic receipt registration section 311 registers various items included in the received electronic receipt information to the corresponding columns of the purchase history table 372 (see FIG. 6).

The electronic receipt delivery section 312 of the electronic receipt management server 30 delivers the electronic receipt information associated with a member ID to the delivery destination address of the member ID registered in the membership table 371. Here, a method of delivering the electronic receipt information is not particularly limited, and the pull-type or the push-type method described above may be used. A member who does not want the delivery of the electronic receipt information is removed from the delivery targets by registering flag information indicating the removal in the membership table 371.

The electronic receipt reception section 612 of the user terminal 60 receives the electronic receipt information delivered from the electronic receipt management server 30. The electronic receipt output section 613 of the user terminal 60 outputs the electronic receipt information received by the electronic receipt reception section 612 to the display unit 66 or the like.

According to the connection between the functional components described above, the electronic receipt information indicating the details of the merchandise purchased by the customer in the store SP is registered in the purchase history table 372 of the electronic receipt management server 30. The electronic receipt information of each member registered in the purchase history table 372 is delivered to the user terminal 60 of the member.

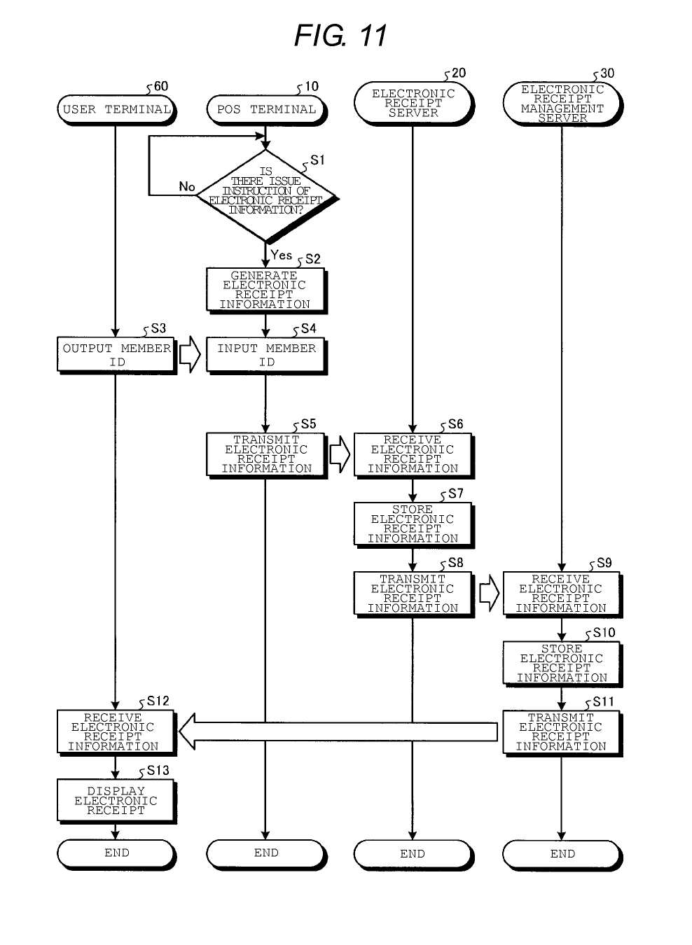

Hereinafter, the operation of the electronic receipt system 1 will be described. First, the operation relating to provision of electronic receipts will be described with reference to FIG. 11.

FIG. 11 is a flowchart of a process relating to provision of electronic receipts carried out in the electronic receipt system 1.

The CPU 11 (sales registration section 111) of the POS terminal 10 determines whether or not a merchandise sales registration process is completed and an instruction to issue the electronic receipt information is input (Step S1). When the instruction to issue the electronic receipt information is not input (Step S1; No), the CPU 11 (sales registration section 111) of the POS terminal 10 goes into a standby state.

Meanwhile, when the instruction to issue the electronic receipt information is input (Step S1; Yes), the CPU 11 (electronic receipt generation section 112) of the POS terminal 10 generates the electronic receipt information including the merchandise ID of the merchandise subjected to the sales registration and the store ID of the store where the sales registration is performed (Step S2).

When a customer requests an electronic receipt, a salesperson asks the customer to present a member ID of the customer using the user terminal 60. The CPU 61 (member ID output section 611) of the user terminal 60 outputs the member ID according to the operation of the customer (Step S3).

The CPU 11 (member ID input unit) of the POS terminal 10 receives the input of the member ID output from the user terminal 60 (Step S4). Next, the CPU 11 (electronic receipt transmission section 114) of the POS terminal 10 associates the input member ID and the electronic receipt information with each other, and transmits the member ID and the electronic receipt information to the electronic receipt server 20 (Step S5).

The CPU 21 (electronic receipt transfer section 211) of the electronic receipt server 20, to which the electronic receipt information is transmitted, receives the electronic receipt information (Step S6). The CPU 21 (electronic receipt transfer section 211) of the electronic receipt server 20 stores the electronic receipt information in the storage unit 27 (Step S7). The CPU 21 (electronic receipt transfer section 211) of the electronic receipt server 20 transmits the electronic receipt information to the electronic receipt management server 30 (Step S8).

The CPU 31 (electronic receipt registration section 311) of the electronic receipt management server 30 receives the electronic receipt information (Step S9). Then, the CPU 31 (electronic receipt registration section 311) of the electronic receipt management server 30 stores the electronic receipt information in the purchase history table 372 of the storage unit 37 (Step S10). The CPU 31 (electronic receipt delivery section 312) of the electronic receipt management server 30 transmits electronic receipt information to the user terminal 60 (Step S11).

The CPU 61 (electronic receipt reception section 612) of the user terminal 60 receives the electronic receipt information (Step S12). The CPU 61 (electronic receipt reception section 612) of the user terminal 60 displays the electronic receipt information on the display unit 66 (Step S13).

As described above, the electronic receipt system 1 executes the process relating to the provision of electronic receipts.

Sales Promotion

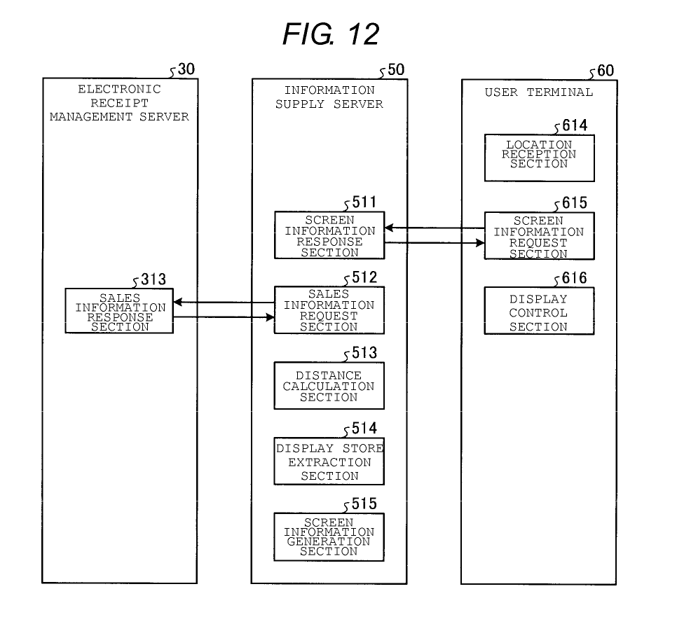

A functional configuration of the electronic receipt system 1 relating to the sales promotion using the electronic receipt information will be described. FIG. 12 illustrates the functional configuration relating to the sales promotion carried out in the electronic receipt system 1.

As shown in FIG. 12, the user terminal 60 includes the location reception section 614, the screen information request section 615, and the display control section 616. The information distribution server 50 includes the screen information response section 511, the sales information request section 512, the distance calculation section 513, the display store extraction section 514, and the screen information generation section 515. The electronic receipt management server 30 includes the sales information response section 313.

The location reception section 614 of the user terminal 60 receives the location of the user terminal 60. Here, the location is, for example, longitude or latitude transmitted from a global positioning system (GPS) satellite. The location is not limited to the information transmitted from the GPS satellite. The location may be, for example, location obtained by a base station that communicates with the user terminal 60.

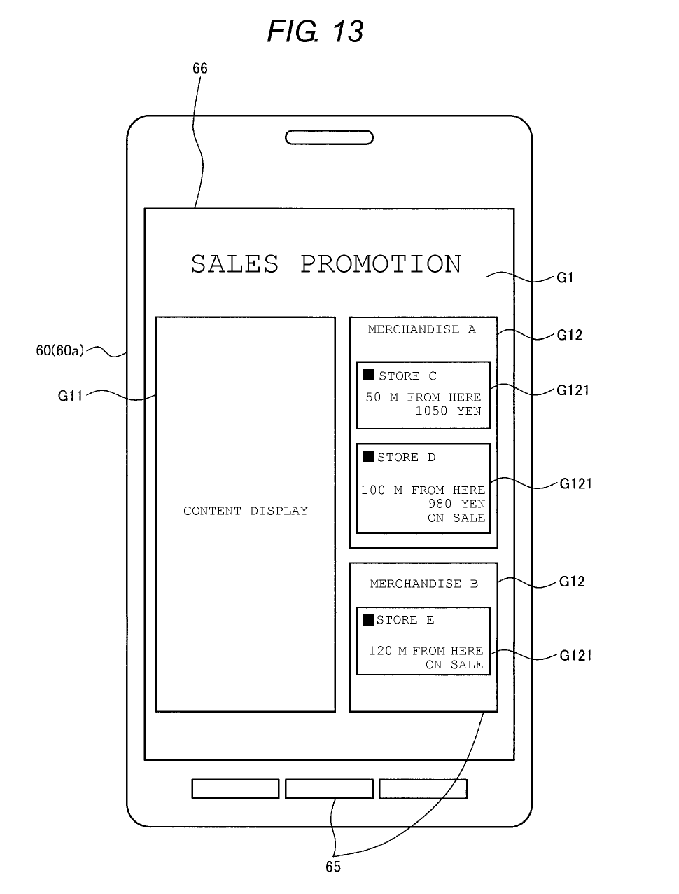

The screen information request section 615 of the user terminal 60 controls transmission of a screen information request signal and reception of sales promotion screen information. Here, the screen information request signal is a signal requesting the information distribution server 50 to send the sales promotion screen information to display a sales promotion screen G1 (see FIG. 13) on the display unit 66 of the user terminal 60. The screen information request signal may be generated in response to a user selecting an icon on a screen of the display unit 66, such as an icon representing a command to show the sales promotion screen G1 or an icon representing a product being promoted. The screen information request section 615 includes the location received by the location reception section 614 in the screen information request signal, and performs the transmission thereof.

When there is the input for displaying the sales promotion screen G1 through the operation unit 65, the screen information request section 615 transmits the screen information request signal to the information distribution server 50. The screen information request section 615 receives the sales promotion screen information transmitted from the information distribution server 50.

The display control section 616 of the user terminal 60 displays the sales promotion screen G1 on the display unit 66 based on the received sales promotion screen information.

The screen information response section 511 of the information distribution server 50 controls reception of the screen information request signal and transmission of screen information. The screen information response section 511 receives the screen information request signal including the location transmitted from the user terminal 60 for displaying the sales promotion screen G1. The screen information response section 511, which is an output section, transmits the generated sales promotion screen information to the user terminal 60 to which the screen information request signal is transmitted.

The sales information request section 512 of the information distribution server 50 controls transmission of a sales information request signal and reception of sales information. The sales information request section 512 transmits the merchandise ID of the merchandise displayed on the sales promotion screen G1 with the sales information request signal. Accordingly, the sales information request section 512 makes a request for the sales information extracted from the electronic receipt information including the transmitted merchandise ID. Here, the sales information includes the store ID of the store where the merchandise displayed on the sales promotion screen G1 has been purchased and the sales price of the purchased merchandise having the transmitted merchandise ID.

The merchandise ID transmitted with the sales information request signal may be a merchandise ID previously designated to be included in the sales promotion screen G1 or a merchandise ID selected in accordance with a predetermined algorithm. Alternatively, a user may input an arbitrary merchandise ID or a select an icon representing a product having the merchandise ID. In this case, the merchandise ID may be received from the user terminal 60 together with the screen information request signal.

The distance calculation section 513 of the information distribution server 50, which is a calculation section, calculates a distance between the store having the store ID included in the sales information and the user terminal 60, based on the store location set in the store setting table 571 stored in the storage unit 57. The distance calculation section 513 calculates a distance (in a straight line) between the store and the user terminal 60 by comparing longitude and latitude set as the store location set in the store setting table 571 and longitude and latitude transmitted from the user terminal 60 with each other, for example. A method of calculating the distance may be any calculation methods. For example, the method of calculating the distance may be a method of calculating a distance of a route introduced by a navigation system which performs route guiding from the current location to a destination.

The display store extraction section 514 of the information distribution server 50 extracts the stores satisfying predetermined distance conditions as candidate stores to be displayed on the sales promotion screen G1, based on the distance calculated by the distance calculation section 513. When the merchandise having the merchandise ID transmitted with the sales information request signal is the merchandise which is on sale in the plurality of stores, it may be confusing to display all stores. According to the present embodiment, the display store extraction section 514 extracts the stores satisfying the predetermined distance conditions calculated by the distance calculation section 513 as candidate stores to be displayed on the sales promotion screen G1. Here, the predetermined distance conditions may include a condition that the distance from the user terminal 60 to the store is in a predetermined range. Alternatively, the distance predetermined conditions may be several stores that are ranked in a higher order.

The sales information response section 313 of the electronic receipt management server 30 controls reception of the sales information request signal and transmission of the sales information. The sales information response section 313, which is a first extraction section, extracts the electronic receipt information including the merchandise ID included in the sales information request signal from the purchase history table 372 stored in the storage unit 37. The sales information response section 313 extracts the store ID of the store that has issued the electronic receipt information from the extracted electronic receipt information and the sales price of the merchandise having the merchandise ID included in the sales information request signal, and generates the sales information.

The sales information response section 313 may add conditions when extracting the electronic receipt information from the purchase history table 372. The sales information response section 313 may add conditions for extracting the electronic receipt information, and the condition may be a generated time of the electronic receipt information. When predetermined time passed from the issue of the electronic receipt information, the merchandise may not be purchased because the merchandise is sold out. By adding the period conditions, the sales information response section 313 may extract the stores that are likely to sell the merchandise. The predetermined period, for example, includes several hours, a day, or a week before the screen information request signal is transmitted or the day when the screen information request signal is transmitted.

The screen information generation section 515 of the information distribution server 50, which is a generation section, generates the sales promotion screen information of the sales promotion screen G1 including the merchandise having the merchandise ID transmitted with the sales information request signal and the candidate stores extracted by the display store extraction section 514. Whether or not the candidate stores are included in the sales promotion screen information is determined based on the setting information in the store setting table 571.

Here, FIG. 13 illustrates an example of the sales promotion screen G1. The sales promotion screen G1 includes the store at which the merchandise having the merchandise ID transmitted with the sales information request signal has been purchased in addition to other contents. The sales promotion screen G1 includes a content display region G11 and an advertisement display region G12. The content display region G11 is a region for displaying content including store information, such as store address, store logo, and a store image, or product information, such as a product image and product detail. The advertisement display region G12 is a region for displaying information of advertised product for each product. The advertisement display region G12 includes a store display region G121 for displaying the store selling the advertised merchandise.

The screen information generation section 515 extracts the store ID from the sales information. When permission of displaying the store having the store ID is set in the store setting table 571, the screen information generation section 515 generates the sales promotion screen information including the store in the store display region G121. Meanwhile, when refusal of displaying the store having the store ID is set, the screen information generation section 515 generates the sales promotion screen information excluding the store from the store display region G121.

A store name, distance information, a sales price, and additional information are displayed in the store display region G121. The store name is a name of the store selling the merchandise. The distance information is a distance between the user terminal 60 and the store. The sales price is a selling price of the merchandise at the store. When the store price display is permitted in the store setting table 571, the screen information generation section 515 generates the sales promotion screen information including the sales price. The additional information is information for the store to additionally display information relating to the sales promotion. When the additional information is set in the store setting table 571, the screen information generation section 515 generates the sales promotion screen information including the additional information.

The sales promotion screen G1 shown in FIG. 13 includes the advertisement display region G12 in which stores C and D are listed as stores that sell merchandise A and the advertisement display region G12 in which a store E is listed as a store that sells merchandise B. The store display region G121 of the store C shown in FIG. 13 includes “50 m from here” as the distance information, “1,050 yen” the sales price, and does not include the additional information. The store display region G121 of the store D includes “100 m from here” as the distance information, “980 yen” as the sales price, and “on sale” as the additional information. The store display region G121 of the store E includes “120 m from here” as the distance information, “on sale” as the additional information, and does not display the sales price.

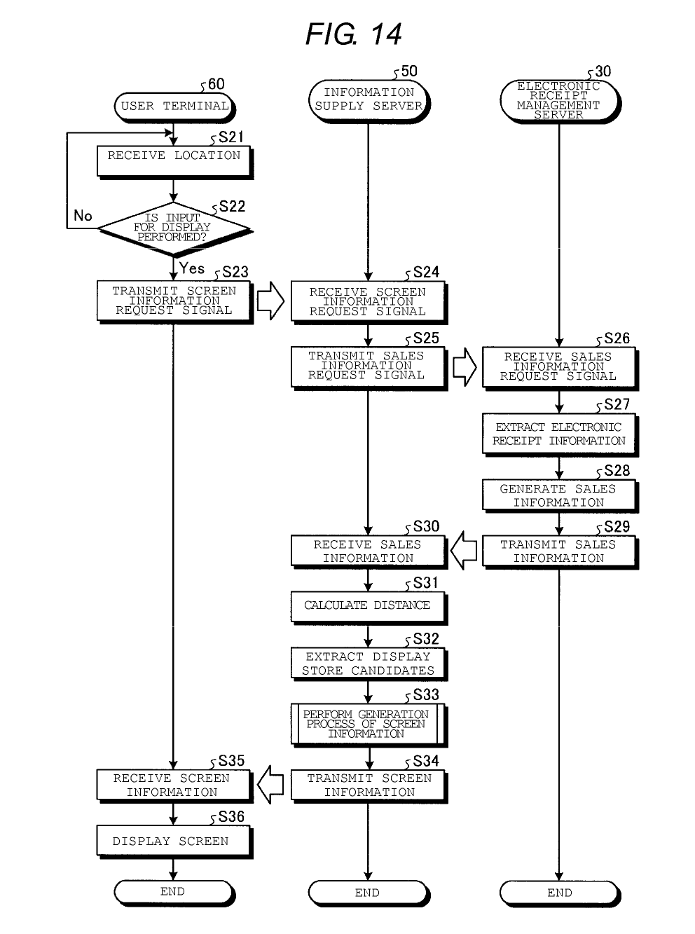

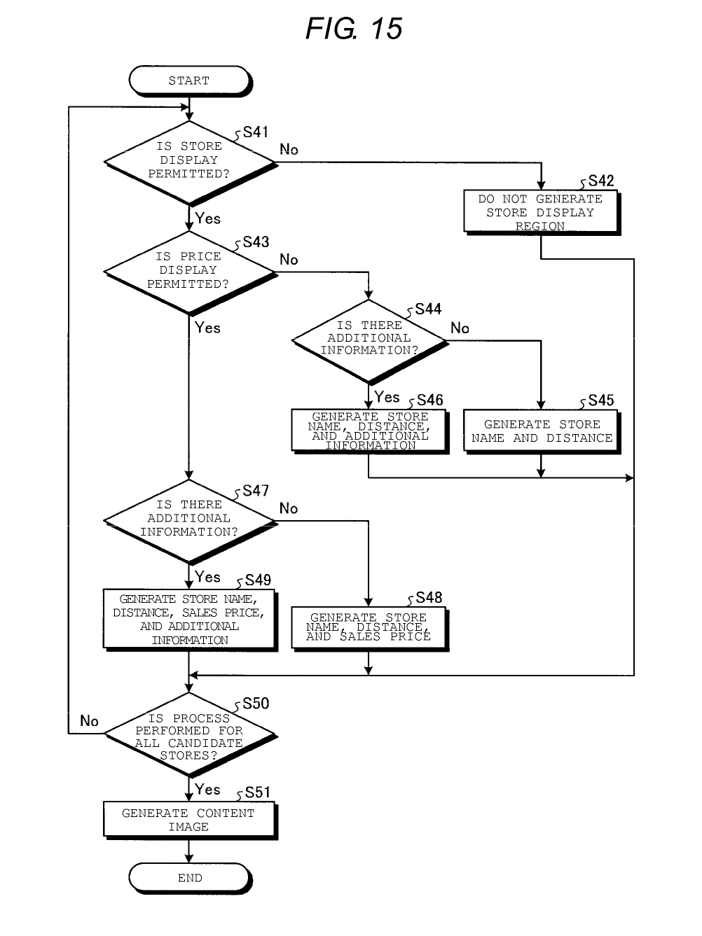

Next, an operation relating to the sales promotion will be described with reference to FIG. 14.

FIG. 14 is a flowchart of a process relating to the sales promotion carried out in the electronic receipt system 1.

First, the CPU 61 (location reception section 614) of the user terminal 60 receives the location information (Step S21). Then, the CPU of the user terminal 60 determines whether or not the input for displaying the sales promotion screen G1 is performed (Step S22).

When there is no input for displaying the sales promotion screen G1 (Step S22; No), the process returns to Step S21 and the CPU 61 (location reception section 614) of the user terminal 60 receives the location information. That is, the CPU 61 of the user terminal 60 receives the latest location information.

Meanwhile, when there is the input for displaying the sales promotion screen G1 (Step S22; Yes), the CPU 61 (screen information request section 615) of the user terminal 60 transmits the screen information request signal to the information distribution server 50 (Step S23).

The CPU 51 (screen information response section 511) of the information distribution server 50 receives the screen information request signal transmitted from the user terminal 60 (Step S24). The CPU 51 (sales information request section 512) of the information distribution server 50 transmits the sales information request signal to the electronic receipt management server 30 (Step S25). At that time, the CPU 51 (sales information request section 512) of the information distribution server 50 includes the merchandise ID set in advance so as to be included in the advertisement display region G12 of the sales promotion screen G1, in the sales information request signal and performs the transmission of the merchandise ID and the sales information request signal.

The CPU 31 (sales information response section 313) of the electronic receipt management server 30 receives the sales information request signal transmitted from the information distribution server 50 (Step S26).

Then, the CPU 31 (sales information response section 313) of the electronic receipt management server 30 extracts the electronic receipt information including the merchandise ID included in the sales information request signal from the purchase history table 372 stored in the storage unit 37 (Step S27).

The CPU 31 (sales information response section 313) of the electronic receipt management server 30 extracts the store ID and the sales price from the extracted electronic receipt information and generates the sales information (Step S28). Here, the store ID of the sales information is a store ID of the store that has issued the extracted electronic receipt information. The sales price of the sales information is a sales price of the merchandise having the merchandise ID included in the sales information request signal, which is sold by the store having the store ID.

The CPU 31 (sales information response section 313) of the electronic receipt management server 30 transmits the generated sales information to the information distribution server 50 to which the sales information request signal is transmitted (Step S29).

The CPU 51 (sales information request section 512) of the information distribution server 50 receives the sales information transmitted from the electronic receipt management server 30 (Step S30).

The CPU 51 (distance calculation section 513) of the information distribution server 50 calculates the distance between the user terminal 60 and the store having the store ID included in the sales information (Step S31). The CPU 51 (display store extraction section 514) of the information distribution server 50 extracts the candidate stores, which are candidates to be displayed on the sales promotion screen G1, based on the calculated distance (Step S32).

The CPU 51 (screen information generation section 515) of the information distribution server 50 executes a process of generating the sales promotion screen information from the calculated distance information and the store setting table 571 regarding the extracted candidate stores (Step S33). The generation process of the sales promotion screen information will be described below.

The CPU 51 (sales information request section 512) of the information distribution server 50 transits the generated sales information to the user terminal 60 to which the screen information request signal is transmitted (Step S34).

The CPU 61 (screen information request section 615) of the user terminal 60 receives the sales promotion screen information which is transmitted from the information distribution server 50 (Step S35). The CPU 61 (display control section 616) of the user terminal 60 displays the sales promotion screen G1 generated from the received sales promotion screen information on the display unit 66 (Step S36).

As described above, the electronic receipt system 1 executes the process relating to the sales promotion for displaying the store selling the merchandise.

An operation relating to the generation process of the sales promotion screen information will be described with reference to FIG. 15.

FIG. 15 is a flowchart of a process relating to the generation process of the sales promotion screen information of the electronic receipt system 1.

First, the CPU 51 (screen information generation section 515) of the information distribution server 50 determines whether or not the permission of display is set by referring to a portion of the store setting table 571 stored in the storage unit 57 corresponding to the store ID of the candidate store (Step S41). When the refusal of display is set (Step S41; No), the CPU 51 (screen information generation section 515) of the information distribution server 50 does not generate the store display region G121 of the store for which the refusal of display is set (Step S42).

Meanwhile, when the permission of display is set (Step S41; Yes), the CPU 51 (screen information generation section 515) of the information distribution server 50 determines whether or not the permission of displaying the sales price is set (Step S43).

When the refusal of displaying the sales price is set (Step S43; No), the CPU 51 (screen information generation section 515) of the information distribution server 50 determines the presence or absence of the additional information (Step S44). When there is no additional information (Step S44; No), the CPU 51 (screen information generation section 515) of the information distribution server 50 generates the store display region G121 including the store name and the distance (Step S45).

When there is the additional information (Step S44; Yes), the CPU 51 (screen information generation section 515) of the information distribution server 50 generates the store display region G121 including the store name, the distance information, and the additional information (Step S46).

Meanwhile, when the permission of displaying the sales price is set (Step S43; Yes), the CPU 51 (screen information generation section 515) of the information distribution server 50 determines the presence or absence of the additional information (Step S47). When there is no additional information (Step S47; No), the CPU 51 (screen information generation section 515) of the information distribution server 50 generates the store display region G121 including the store name, the distance, and the sales price (Step S48).

When there is the additional information (Step S47; Yes), the CPU 51 (screen information generation section 515) of the information distribution server 50 generates the store display region G121 including the store name, the distance, the sales price, and the additional information (Step S49).

The CPU 51 (screen information generation section 515) of the information distribution server 50 determines whether or not the process regarding all candidate stores is completed (Step S50). When the process for all candidate stores is not completed (Step S50; No), the process of the CPU 51 (screen information generation section 515) of the information distribution server 50 returns to Step S41.

Meanwhile, when process for all candidate stores is completed (Step S50; Yes), the CPU 51 (screen information generation section 515) of the information distribution server 50 generates a content screen of the content display region G11 (Step S51).

As described above, the electronic receipt system 1 executes the generation process of the sales promotion screen information.

As described above, according to the electronic receipt system 1 according to the exemplary embodiment, the electronic receipt management server 30 stores the electronic receipt information in which the merchandise ID of the merchandise subjected to the sales registration and the store ID of the store subjected to the sales registration are recorded, in the purchase history table 372 of the storage unit 37. The electronic receipt management server 30 extracts the electronic receipt information including the predetermined merchandise ID from the purchase history table 372. The information distribution server 50 calculates the distance between the store that has issued the electronic receipt information extracted by the electronic receipt management server 30 and the user terminal 60, based on the setting information stored in the store setting table 571 of the storage unit 57. The information distribution server 50 extracts the store satisfying the predetermined distance conditions based on the calculated distance, and generates the screen information including the information relating to the extracted store and the information relating to the predetermined merchandise. The information distribution server 50 transmits the generated screen information to the user terminal 60. Accordingly, the electronic receipt system 1 according to the exemplary embodiment may display the electronic receipt introduction store for the location of the consumer in the merchandise advertisement on the Internet. Therefore, the consumer may purchase the desired merchandise in the near electronic receipt introduction store and the electronic receipt introduction store may expect improvement of sales.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

In the exemplary embodiment, the store setting table 571 is stored in the storage unit 57 of the information distribution server 50. However, the store setting table 571 may be stored in a server device other than the information distribution server 50. For example, the store setting table 571 may be stored in the electronic receipt management server 30.

In the exemplary embodiment, the information distribution server 50 receives the location from the user terminal 60. However, the method of acquiring the location of the user terminal 60 is not limited thereto. The address accommodated in the membership table 371 of the electronic receipt management server 30 may be, for example, acquired as the location of the user terminal 60. In this case, the member ID input to the user terminal 60 may be transmitted to the electronic receipt management server 30, and the member ID associated with the member ID may be received from the electronic receipt management server 30.

In the exemplary embodiment, the store display region G121 for displaying the information relating to the store selling the merchandise is displayed in the sales promotion screen G1. However, the screen for displaying the store display region G121 is not limited thereto. The screen for displaying the store display region G121 may be any other screens. For example, the screen may be a screen of an entertainer's blog or a news article.

The program executed in each device of the exemplary or the modification example is pre-installed in the storage medium (ROM or storage unit) included in each device, but there is no limitation. For example, the program may be provided by being recorded in a computer-readable recording medium such as a CD-ROM, a flexible disk (FD), a CD-R, or a digital versatile disk (DVD) in an installable form or an executable form. The storage medium is not limited to an independent medium from a computer or an embedded system, and a storage medium which downloads the program and temporarily stores the program transmitted through a LAN or the Internet is also included.

The program executed in each device according to the exemplary embodiment or the modification example may be stored in a computer connected to a network such as the Internet and the program may be downloaded through the network, or distributed through the network such as the Internet.

What is claimed is:

1. An electronic content filtering server between a mobile computing device and an electronic receipt server, comprising:
a communication unit configured to communicate with the mobile computing device and the electronic receipt server, and to receive from the mobile computing device a request for promotion information and a location of the mobile computing device, and from the electronic receipt server, store information of stores where a product being promoted has been sold; and
a processing unit programmed to perform a filtering function on the store information received from the electronic receipt server and supply a filtered result to the mobile computing device through the communication unit, wherein the processing unit, when performing the filtering function, carries out the steps of:
determining a distance between the location of the mobile computing device and each of the stores where the product being promoted has been sold;
selecting one or more stores based on a distance from the mobile computing device; and
generating the filtered result to be supplied to the mobile computing device, the filtered result including a product name of the product being promoted, and a store name of and a distance to each of the selected stores.

2. The electronic content filtering server according to claim 1, further comprising:
a storage unit in which a store location with respect to each of the stores where the product being promoted has been sold, is stored, wherein
the processing unit determines the distance between the location of the mobile computing device and said each of the stores, based on the location of the mobile computing device and the stored store location.

3. The electronic content filtering server according to claim 2, wherein
the distance includes a distance along a route from a current location of the mobile computing device to said each of the stores.

4. The electronic content filtering server according to claim 1, wherein
stores located within a predetermined distance from the mobile computing device are selected.

5. The electronic content filtering server according to claim 1, further comprising:
a storage unit storing a store setting table including data indicating whether or not each of the stores where the product being promoted has been sold, permits disclosure of its store name, wherein
the processing unit selects the one or more stores that permit disclosure of its the store name.

6. The electronic content filtering server according to claim 1, further comprising:
a storage unit storing a store setting table including data indicating whether or not each of the stores where the product being promoted has been sold permits disclosure of a product price of the product, wherein
the filtered result includes the product price for stores that permit disclosure of the product price, and does not include the product price for stores that do not permit disclosure of the product price.

7. The electronic content filtering server according to claim 1, further comprising:
a storage unit storing a promotion setting table including a product ID of each product being promoted, wherein
the processing unit is further configured to select the product being promoted from the products in the promotion setting table and transmit a product ID of the selected product to the electronic receipt server, in response to which the electronic receipt server returns the store information of stores that have sold the product having the product ID.

8. The electronic content filtering server according to claim 1, wherein
the store information of stores where the product being promoted has been sold is extracted from electronic receipt data for purchases of the product, which are recorded in the electronic receipt server.

9. The electronic content filtering server according to claim 8, wherein
the store information is extracted from electronic receipt data for purchase of the product that occurred within a predetermined time period from a current time.

10. The electronic content filtering server according to claim 1, wherein
the filtered result includes an image of the product being promoted.

11. A method for filtering electronic content, comprising:
receiving from a mobile computing device a location of the mobile computing device;
extracting store information of stores where a product being promoted has been sold, from electronic receipt data of purchases of the product;
determining a distance between the location of the mobile computing device and each of the stores;
selecting one or more stores based on a distance from the mobile computing device; and
generating a filtered result including a product name of the product being promoted, and a store name and a distance to each of the selected stores.

12. The method according to claim 11, further comprising:
storing a store location of each of the stores where the product being promoted has been sold, wherein
the distance between the location of the mobile computing device and said each of the stores is determined based on the location of the mobile computing device and the stored store location.

13. The method according to claim 12, wherein
the distance includes a distance along a route from a current location of the mobile computing device to said each of the stores.

14. The method according to claim 11, wherein
stores located within a predetermined distance from the mobile computing device are selected.

15. The method according to claim 11, further comprising:
storing a store setting table including data indicating whether or not each of the stores where the product being promoted has been sold, permits disclosure of its store name, wherein
only stores that permit disclosure of its store name are selected.

16. The method according to claim 11, further comprising:
storing a store setting table including data indicating whether or not each of the stores where the product being promoted has been sold, permits disclosure of a product price of the product, wherein
the filtered result includes the product price for stores that permit disclosure of the product price, and does not include the product price for stores that do not permit disclosure of the product price.

17. The method according to claim 11, further comprising:
storing a promotion setting table including information of each product being promoted;
selecting the product being promoted from the products in the promotion setting table; and
the store information extracted from the electronic receipt data is for the selected product.

18. The method according to claim 11, wherein
the electronic receipt data from which the store information is extracted is for purchases that occurred within a predetermined time period from a current time.

19. The method according to claim 11, wherein
the filtered result includes an image of the product being promoted.

20. The method according to claim 11, further comprising:
transmitting the filtered result to the mobile computing device for display of the filtered result.
